(19) United States
(12) Patent Application Publication
(10) Pub. No.: US 2016/0281583 A1
(43) Pub. Date: Sep. 29, 2016

(54) CYLINDER BLOCK OF INTERNAL COMBUSTION ENGINE

(71) Applicant: TOYOTA JIDOSHA KABUSHIKI KAISHA, Aichi-ken (JP)

(72) Inventor: Ryo MICHIKAWAUCHI, Numazu-shi, Shizuoka-ken (JP)

(73) Assignee: TOYOTA JIDOSHA KABUSHIKI KAISHA, Toyota-shi, Aichi-ken (JP)

(21) Appl. No.: 15/032,863

(22) PCT Filed: Oct. 27, 2014
(86) PCT No.: PCT/IB2014/002229

§ 371 Date: Apr. 28, 2016

(30) Foreign Application Priority Data
Oct. 30, 2013 (JP) 2013-225840

(51) Int. Cl. F01P 3/02; F02F 1/14

(52) U.S. Cl. CPC F01P 3/02; F02F 1/14; F01P 2003/021; F01P 2003/028

(57) ABSTRACT

A cylinder block of an internal combustion engine, the cylinder block includes a partition wall arranged between a plurality of cylinder bores, the cylinder bores are adjacent to one another; and a coolant passage that is arranged in the partition wall. The coolant passage includes (i) a large diameter hole not intersecting a virtual plane, the virtual plane includes central axes of the plurality of cylinder bores and (ii) a plurality of small diameter holes each having a diameter that is smaller than a diameter of the large diameter hole, the plurality of small diameter holes communicate with the large diameter hole, and the plurality of small diameter holes extend in a different direction than a direction that the large diameter hole extends, the plurality of small diameter holes intersect the virtual plane.

### BACKGROUND OF THE INVENTION

1. Field of the Invention

The invention relates to a cylinder block of an internal combustion engine.

2. Description of Related Art

Japanese Patent Application Publication No. 01-159111 (JP 01-159111 A), Japanese Patent Application Publication No. 05-141307 (JP 05-141307 A), Japanese Patent Application Publication No. 2013-068175 (JP 2013-068175 A), and Japanese Patent Application Publication No. 07-119541 (JP 07-119541 A) each describe a cylinder block with a coolant passage formed in a partition wall between adjacent cylinder bores.

This kind of coolant passage is formed by machining, e.g., drilling, a cylinder block formed by casting. The diameter of the coolant passage is preferably small considering the strength of the partition wall. However, if the diameter of the coolant passage is small, cooling performance may decrease. Therefore, a plurality of small diameter coolant passages may be provided. However, providing many coolant passages will increase the number of man-hours for machining.

### SUMMARY OF THE INVENTION

The invention thus provides a cylinder block of an internal combustion engine in which both an increase in the number of man-hours for machining and a decrease in cooling performance due to smaller diameter coolant passages are suppressed.

One aspect of the invention relates to a cylinder block of an internal combustion engine, the cylinder block includes a partition wall arranged between a plurality of cylinder bores, the cylinder bores are adjacent to one another; and a coolant passage that is arranged in the partition wall. This coolant passage includes a large diameter hole not intersecting a virtual plane, the virtual plane includes central axes of the plurality of cylinder bores, and a plurality of small diameter holes each having a diameter that is smaller than a diameter of the large diameter hole. The plurality of small diameter holes communicate with the large diameter hole, and the plurality of small diameter holes extend in a different direction than a direction that the large diameter hole extends. The plurality of small diameter holes intersects the virtual plane.

In the cylinder block described above, at least one of the large diameter hole or the plurality of small diameter holes may be open to a water jacket arranged along an outer periphery of the plurality of cylinder bores, and at least one other of the large diameter hole or the plurality of small diameter holes may be open to an upper surface of the partition wall.

In the cylinder block described above, at least one of the plurality of small diameter holes may be open to the water jacket, and at least one other of the plurality of small diameter holes may be open to the upper surface of the partition wall.

In the cylinder block described above, the large diameter hole and the plurality of small diameter holes may be open to an upper surface of the partition wall.

In this way, it is possible to provide a cylinder block of an internal combustion engine, in which both an increase in the number of man-hours for machining and a decrease in cooling performance due to smaller diameter coolant passages are suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a plan view of a cylinder block according to one example embodiment of the invention;

FIG. 1B is a partial enlarged view of a partition wall in FIG. 1A;

FIG. 2A is a sectional view taken along line IIA-IIA in FIG. 1B;

FIG. 2B is a sectional view of a cylinder block according to a comparative example;

FIG. 3A is a sectional view of a cylinder block according to a first modified example;

FIG. 3B is a sectional view of a cylinder block according to a second modified example; and

FIG. 4 is a sectional view of a cylinder block according to a third modified example.

### DETAILED DESCRIPTION OF EMBODIMENTS

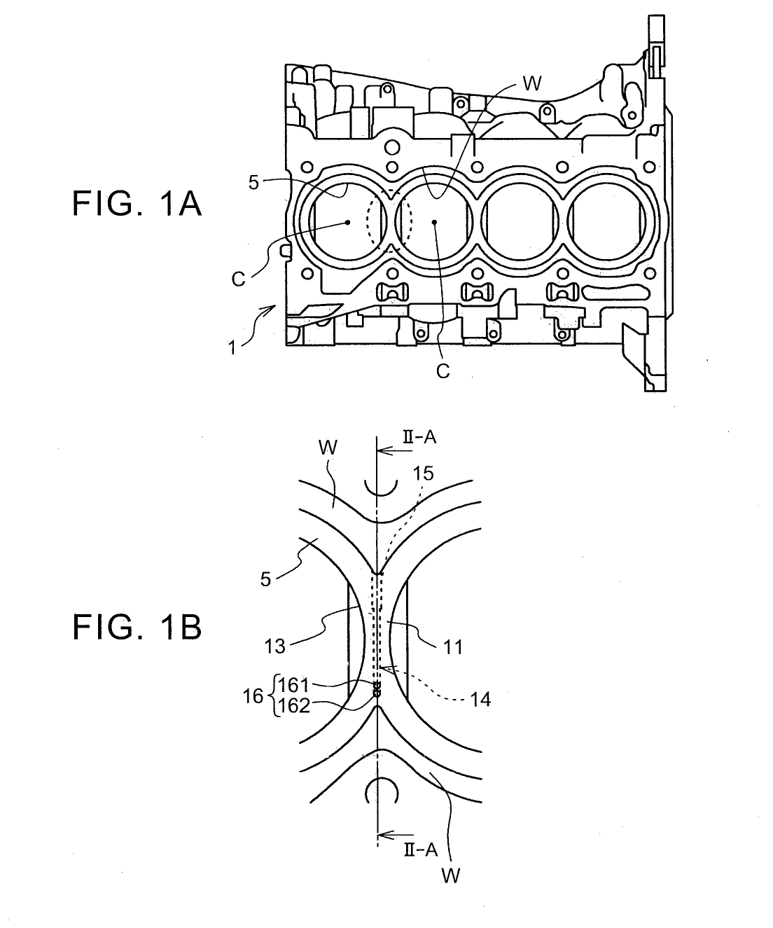

FIG. 1A is a plan view of a cylinder block 1. The cylinder block 1 is for an in-line 4 cylinder engine. However, the cylinder block 1 is not limited to this. A plurality of cylindrical cylinder bores 5 that define combustion chambers are formed in the cylinder block 1. Four of these cylinder bores 5 are formed lined up in a row. A water jacket W that follows an outer periphery of these four cylinder bores 5 is formed in the cylinder block 1. Central axes C of some of the cylinder bores 5 are shown in FIG. 1A. A cylinder head is mounted so as to cover an upper portion of the cylinder bores 5, to an upper surface of the cylinder block 1, such that the combustion chambers are formed.

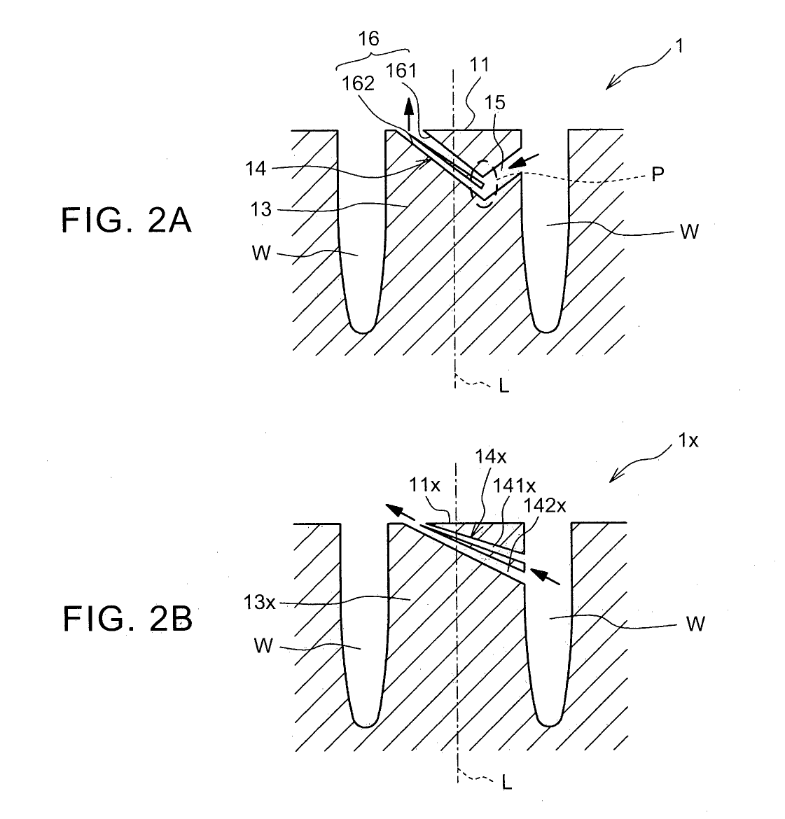

FIG. 1B is a partial enlarged view of a partition wall 13 of the portion encircled by the broken line in FIG. 1A. FIG. 2A is a sectional view taken along line IIA-IIA in FIG. 1B. A coolant passage 14 is formed in the partition wall 13 positioned between adjacent cylinder bores 5. The partition wall 13 is thinnest at a portion through which an alternate long and short dash line L indicating a virtual plane that includes the central axes C of the adjacent cylinder bores 5 passes, i.e., at the center portion. More specifically, the coolant passage 14 passes through this center portion.

As shown in FIG. 2A, the coolant passage 14 includes a hole 15 open to the water jacket W, and a hole 16 that is communicated with the hole 15 and is open to an upper surface 11 of the partition wall 13. The cylinder head is mounted to the upper surface 11 side of the partition wall 13. The holes 15 and 16 extend in different linear directions, and extend downward at an angle toward the alternate long and short dash line L. That is, the coolant passage 14 is bent midway and formed in a general V-shape when viewed at a cross section perpendicular to the virtual plane that includes the central axes C of the cylinder bores 5. Because the coolant passage 14 is on the whole formed in a general V-shape that is bent midway, the length of the entire coolant passage 14 is ensured. As a result, a decrease in cooling performance due to the diameter of the coolant passage being smaller is suppressed.

The hole 16 includes a plurality of small diameter holes 161 and 162. The small diameter hole 161 and the small diameter hole 162 are lined up in a height direction that is orthogonal to a thickness direction of the partition wall 13, i.e., lined up in a reciprocating direction of pistons. The small diameter holes 161 and 162 are arranged a predetermined distance apart. In FIG. 2A, the small diameter holes 161 and 162 are lined up in a longitudinal direction. The size of the diameter of each of the small diameter holes 161 and 162 is smaller than the size of the diameter of the hole 15. The small diameter holes 161 and 162 in FIG. 2A extend linearly substantially parallel to each other, but they do not have to be parallel. The hole 15 and the small diameter holes 161 and 162 are formed by machining, using a drill, the cylinder block 1 that is formed by casting. The hole 15 is one example of a large diameter hole. The small diameter holes 161 and 162 are one example of a plurality of small diameter holes.

The hole 15 and the small diameter holes 161 and 162 are communicated at a communicating portion P that is at substantially the same position. This communicating portion P is at a position offset to the right of the alternate long and short dash line L. For example, when the right side in FIG. 2A is an intake passage side and the left in FIG. 2A is an exhaust passage side, the communicating portion P is positioned on the intake passage side. Therefore, the small diameter holes 161 and 162 extend through the alternate long and short dash line L, and pass through the center portion where the thickness of the partition wall 13 is thin. That is, the small diameter holes 161 and 162 intersect the virtual plane that includes the central axes of the cylinder bores 5. In contrast, the hole 15 extends to a point away from the virtual plane and does not intersect it.

Coolant passes through the hole 15 from the water jacket W and flows into the small diameter holes 161 and 162 and to the cylinder head side. In this way, the single hole 15 is formed on the upstream side of the coolant passage 14, and the small diameter holes 161 and 162 are formed on the downstream side of the coolant passage 14.

FIG. 2B is a sectional view of a cylinder block lx of a comparative example. A coolant passage 14x formed in a partition wall 13x includes small diameter holes 141x and 142x that are parallel and extend linearly. The small diameter holes 141x and 142x are both open at an upper surface 11x and the water jacket W.

If the interval between adjacent cylinder bores is narrow because the engine is small or the like, i.e., if the partition wall is thin, the drill may interfere with a cylinder liner at the time of machining. Also, if the coolant passage reaches the cylinder liner, coolant may leak out from between the cylinder liner and the boundary of the cylinder block. Further, the diameter of this kind of coolant passage is preferably small considering the strength of the partition wall. However, if the diameter of the coolant passage is small, cooling performance may decrease. Therefore, a plurality of the small diameter holes 141x and 142x that have relatively small diameters may be provided, as in the cylinder block 1x of the comparative example. However, the flow rate of coolant that passes through each of these small diameter holes 141x and 142x is small. Therefore, if the small diameter holes 141x and 142x are long, coolant at a small flow rate may be subject to a large amount of heat while it flows through each of these small diameter holes 141x and 142x. As a result, the temperature of the coolant may tend to rise and the cooling performance may decrease.

In this example embodiment, the small diameter holes 161 and 162 extend through the center portion of the partition wall 13, but are communicated midway with the single hole 15. Therefore, the small diameter holes 161 and 162 are formed shorter than the small diameter holes 141x and 142x, thus enabling an increase in the temperature of the coolant in the small diameter holes 161 and 162 to be suppressed.

In this way, the small diameter holes 161 and 162 having small diameters are lined up in the height direction of the partition wall 13 and extend to the center portion, and the hole 15 having a large diameter is away from the center portion of the partition wall 13. As a result, the strength of the partition wall 13 is inhibited from decreasing as a result of the hole 15 that has a large diameter extending to the center portion of the partition wall 13. Also, because the hole 15 is away from the center portion of the partition wall 13, it is less likely that the drill will interfere with the cylinder liner at the time of machining.

The hole 15 is away from the center portion of the partition wall 13, so the size of the diameter of the hole 15 is able to be ensured. As a result, a decrease in cooling performance of the engine is able to be suppressed. Also, the hole 15 is a single hole, so an increase in the number of man-hours for machining is also able to be suppressed. As described above, with the cylinder block 1 of this example embodiment, both a decrease in cooling performance and an increase in the number of man-hours for machining are suppressed.

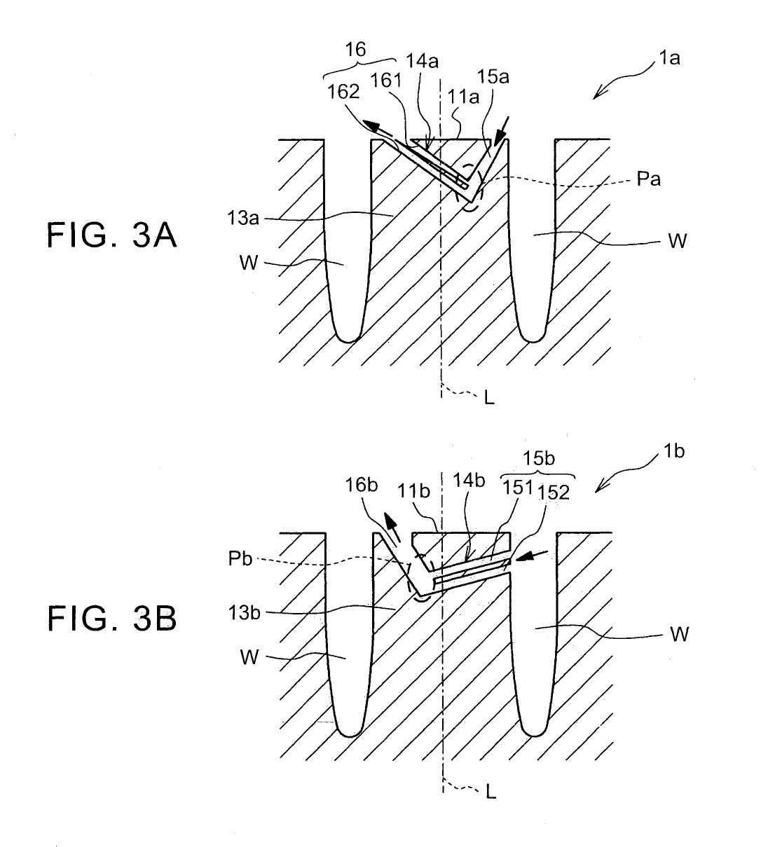

FIG. 3A is a sectional view of a cylinder block la according to a first modified example. In the modified example described below, redundant descriptions will be omitted by using reference characters corresponding to those used in the example embodiment described above. A coolant passage 14a formed in a partition wall 13a includes holes 15a and 16. The hole 15a is open to an upper surface 11a, but is not open to the water jacket W. That is, the hole 15a and the small diameter holes 161 and 162 are all open to the upper surface 11a. Coolant passes through the holes 15a and 16 from the cylinder head side, and then flows to the cylinder head side again. With this kind of structure as well, a communicating portion Pa is away from the alternate long and short dash line L, and the small diameter holes 161 and 162 pass through the alternate long and short dash line L, but the hole 15a does not. Therefore, a decrease in cooling performance and an increase in the number of man-hours for machining are both able to be suppressed. The direction in which the coolant flows may also be a direction opposite the direction shown in FIG. 3A.

FIG. 3B is a sectional view of a cylinder block 1b according to a second modified example. Unlike the example embodiment and the first modified example described above, a coolant passage 14b formed in a partition wall 13b includes holes 15b and 16b. The hole 15b includes two small diameter holes 151 and 152. The hole 16b is a single hole. The small diameter holes 151 and 152 pass through the alternate long and short dash line L. That is, a communicating portion Pb is positioned to the left of the alternate long and short dash line L. When the right side in FIG. 3B is the intake passage side and the left side in FIG. 3B is the exhaust passage side, the communicating portion Pb is positioned on the exhaust passage side. The small diameter holes 151 and 152 are open to the water jacket W. The hole 16b is open to an upper surface 11b. Coolant flows from the water jacket W to the cylinder head side through the holes 15b and 16b. In this way, a plurality of small holes are formed on the upstream side of the coolant passage 14b, and the single hole 16b is formed on the downstream side of the coolant passage 14b. With this kind of structure as well, the communicating portion Pb is away from the alternate long and short dash line L, and the small diameter holes 151 and 152 pass through the alternate long and short dash line L but the hole 16b does not. Therefore, a decrease in cooling performance and an increase in the number of man-hours for machining are both able to be suppressed.

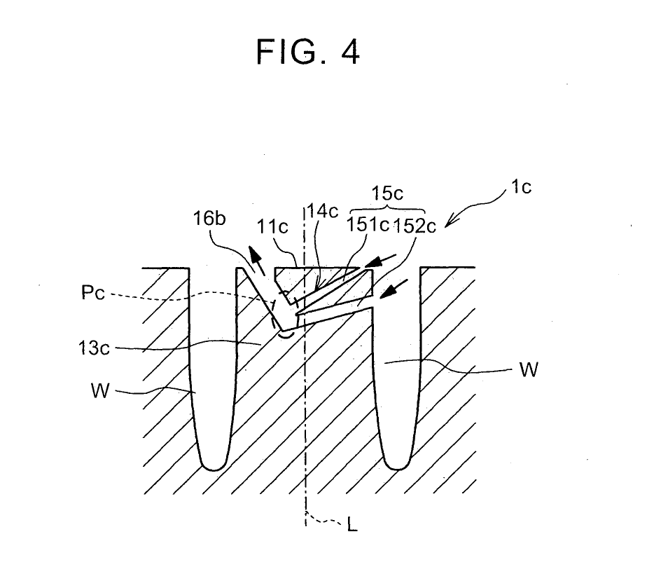

FIG. 4 is a sectional view of a cylinder block 1c according to a third modified example. A coolant passage 14c formed in a partition wall 13c includes holes 15c and 16b. The hole 15c includes small diameter holes 151c and 152c. The small diameter hole 151c is open to the upper surface 11c, and the small diameter hole 152c is open to the water jacket W. Also, the small diameter holes 151c and 152c are not parallel and extend in different directions. Coolant flows from the cylinder head side to the small diameter hole 151c, and from the water jacket W to the small diameter hole 152c, and converges at a communicating portion Pc, after which it flows through the hole 16b to the cylinder head side. With this kind of structure as well, the communicating portion Pc is away from the alternate long and short dash line L, and the small diameter holes 151c and 152c pass through the alternate long and short dash line L, but the hole 16b does not. Therefore, a decrease in cooling performance and an increase in the number of man-hours for machining are both able to be suppressed.

While example embodiments of the invention have been described in detail, the invention is not limited to these specific example embodiments. Various variations and modifications are also possible within the scope of the invention described in the claims.

In the example embodiment described above, the plurality of small diameter holes all have substantially the same diameter but they are not limited to this. For example, the diameters of the plurality of small diameter holes may all be different.

The number of the plurality of small diameter holes may be two or three or more.

Also, at least one of the plurality of small diameter holes may be formed in a position near one side of adjacent cylinder bores. That is, the plurality of small diameter holes need only be lined up in a direction other than the direction in which adjacent cylinder bores are lined up, i.e., lined up in a direction other than the thickness direction of the partition wall.

At least one of the large diameter hole and the plurality of small diameter holes may have a tapered shape in which the diameter gradually becomes smaller or larger.

What is claimed is:

1. A cylinder block of an internal combustion engine, the cylinder block comprising
a partition wall arranged between a plurality of cylinder bores, the cylinder bores being adjacent to one another, and
a coolant passage that is arranged in the partition wall, the coolant passage including:
a large diameter hole not intersecting a virtual plane, the virtual plane including central axes of the plurality of cylinder bores;
a plurality of small diameter holes each having a diameter that is smaller than a diameter of the large diameter hole, the plurality of small diameter holes communicating with the large diameter hole, and the plurality of small diameter holes extending in a different direction than a direction that the large diameter hole extends, the plurality of small diameter holes intersecting the virtual plane, and
each of the large diameter hole and the plurality of small diameter holes extends downward at an angle toward the virtual plane.

2. The cylinder block of the internal combustion engine according to claim 1, wherein
at least one of the large diameter hole or the plurality of small diameter holes is open to a water jacket arranged along an outer periphery of the plurality of cylinder bores, and at least one other of the large diameter hole or the plurality of small diameter holes is open to an upper surface of the partition wall.

3. The cylinder block of the internal combustion engine according to claim 2, wherein
at least one of the plurality of small diameter holes is open to the water jacket, and at least one other of the plurality of small diameter holes is open to the upper surface of the partition wall.

4. The cylinder block of the internal combustion engine according to claim 1, wherein the large diameter hole and the plurality of small diameter holes are open to an upper surface of the partition wall.
